(19) United States
(12) Patent Application Publication
(10) Pub. No.: US 2003/0062703 A1
(43) Pub. Date: Apr. 3, 2003

(54) Front wheel suspension assembly for an electric scooter

(76) Inventor: Samuel Lin, Chia Yi Hsien (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/968,110

(22) Filed: Oct. 1, 2001

(51) Int. Cl. B60G 1/00

(52) U.S. Cl. 280/124.125; 280/124.179

(57) ABSTRACT

A suspension assembly has two plates, two sleeves, two wheel mounts and two shock absorbers. Each plate is pivotally attached to one side of the front end of the frame in a first lateral direction. Each sleeve is pivotally attached to one of the plates in a second lateral direction parallel to the first lateral direction. Each wheel mount is pivotally attached to one of the sleeves in a vertical direction perpendicular to the first and second lateral directions. One front wheel is rotatably mounted on each wheel mount. Each shock absorber is pivotally connected between each wheel mount and the frame of the scooter. Accordingly, the front wheels are independently suspended. A force applied to the front wheels will be absorbed by the shock absorber. To steer and to drive the scooter is more comfortable.

### BACKGROUND OF THE INVENTION

1. Field of the Invention

The present invention relates to a suspension assembly, and more particularly to a front wheel suspension assembly for an electric scooter.

2. Description of Related Art

An electric scooter is used to help a person to move from place to place at a low speed. The conventional electric scooter substantially comprises a frame, two front wheels, two rear wheels, a seat, an electric motor and a steering bar. An axle is mounted on each end of the frame. A wheel mount is pivotally connected to each end of the axle attached to the front end of the frame. Each front wheel is rotatably attached to one of the wheel mounts. Each rear wheels is rotatably mounted on one end of the axle attached to the rear end of the frame. The seat is mounted on the frame for a user to sit. The electric motor is mounted on the frame to drive the rear wheels. The steering bar is pivotally mounted on the frame and is connected to the wheel mounts with a linking device. When the steering bar is pivoted relative to the frame, the wheel mounts with the front wheels will be pivoted relative to the frame through the transmission of the linking device. Accordingly, the direction of the electric scooter is controlled.

However, there is no suspension device for the front wheels of the conventional electric scooter. When one of the front wheels bumps an object, the force applied to the front wheel will be directly transmitted to the steering bar and frame. To hold and turn the steering bar and to drive the electric scooter are uncomfortable. In addition, when one of the front wheels sinks into a pothole in the ground, the other front wheel will be lifted off the ground. The electric scooter will become unstable.

To overcome the shortcomings, the present invention provides a suspension assembly to mitigate or obviate the aforementioned problems.

### SUMMARY OF THE INVENTION

The main objective of the invention is to provide a front wheel suspension assembly for an electric scooter wherein the front wheels are independently suspended. The suspension assembly has two plates, two sleeves, two wheel mounts and two shock absorbers. Each plate is pivotally attached to one side of the front end of the frame in a first lateral direction. Each sleeve is pivotally attached to one of the plates in a second lateral direction parallel to the first lateral direction. Each wheel mount is pivotally attached to one of the sleeves in a longitudinal direction perpendicular to the first and second lateral directions. One front wheel of the scooter is rotatably mounted on each wheel mount. Each shock absorber is pivotally connected between each wheel mount and the frame of the scooter. In such a suspension assembly, the front wheels are independently suspended. This keeps the front wheels from lifting off the ground when the electric scooter is in motion. Any force applied to the front wheels will be absorbed by the shock absorber. To steer and to drive the scooter is more comfortable.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a front wheel suspension assembly in accordance with the present invention on the front of an electric scooter frame;

FIG. 2 is an exploded perspective view of the front wheel suspension assembly in FIG. 1;

FIG. 3 is a front plan view of the suspension assembly in FIG. 1; and

FIG. 4 is an operational front plan view of the suspension assembly in FIG. 1 with the front wheels of scooter at different levels on the ground.

### DETAILED DESCRIPTION OF PREFERRED EMBODIMENT

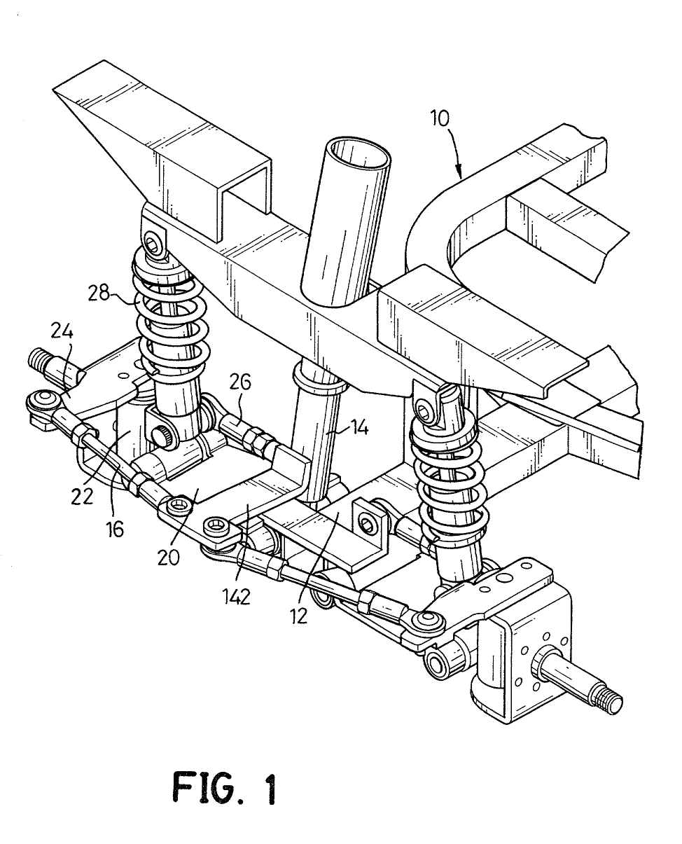

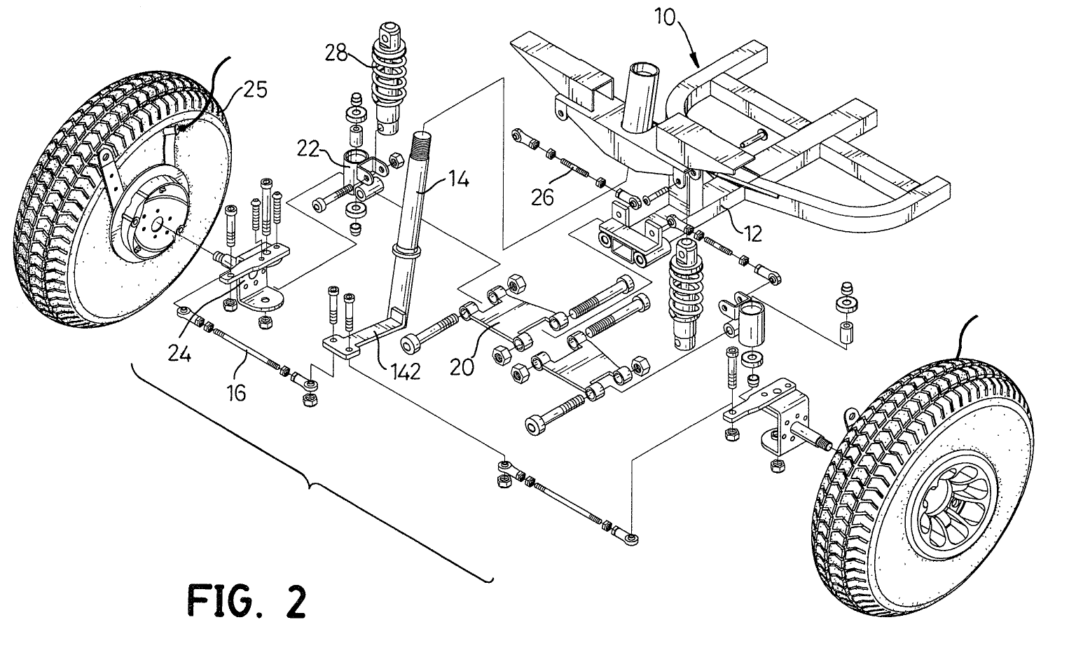

With reference to FIGS. 1 and 2, a front wheel suspension assembly for an electric scooter in accordance with the present invention comprises two plates (20), two vertical sleeves (22), two wheel mounts (24) and two shock absorbers (28). Each plate (20) is pivotally attached in a first lateral direction to one side of the frame (10) of the electric scooter with a pivot pin (not numbered). In practice, a front tube (12) integrally extends from the front end of the frame (10) to which the plates (20) are pivotally attached. A longitudinal sleeve (22) is pivotally attached to each of the plates (20) in a second lateral direction parallel to the first lateral direction. Each wheel mount (24) is pivotally attached to each sleeve (22) in a vertical direction perpendicular to the first and second lateral directions. Each front wheel (25) of the scooter is rotatably attached to one of the wheel mounts (24). Each shock absorber (28) is pivotally connected to one of the wheel mounts (24) and the frame (10) of the scooter. In addition, a connecting bar (26) is connected between each sleeve (22) and the frame (10) of the scooter to limit the angle of the pivotal rotation of each sleeve (22) relative to the plate (20). One end of each connecting bar (26) is pivotally connected to one sleeve (22). The other end of each connecting bar (26) is pivotally attached to the frame (10).

A steering bar (14) is rotatably mounted on the frame (10) and operationally connected to the wheel mounts (24) with a linking device (not numbered). Consequently, the direction of the electric scooter is controlled with the steering bar (14) through the transmission of the linking device. In practice, the linking device comprises a connecting plate (142) and two tie rods (16). The connecting plate (142) is attached to the bottom of the steering bar (14). Each tie rod (16) is pivotally connected between the connecting plate (142) and one of the wheel mounts (24). When the steering bar (14) is rotated, the tie rods (16) will simultaneously push and pull the corresponding wheel mounts (24) and cause them to pivot relative to the sleeves (22) in a longitudinal direction. The wheel mounts (24) with the front wheels (25) will rotate relative to the frame (10). The direction of the electric scooter is controlled.

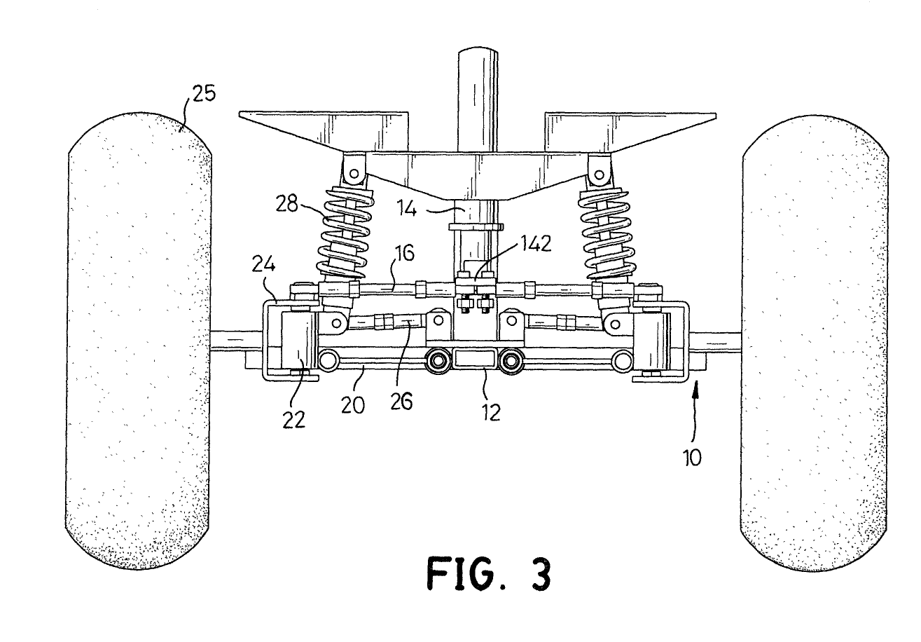

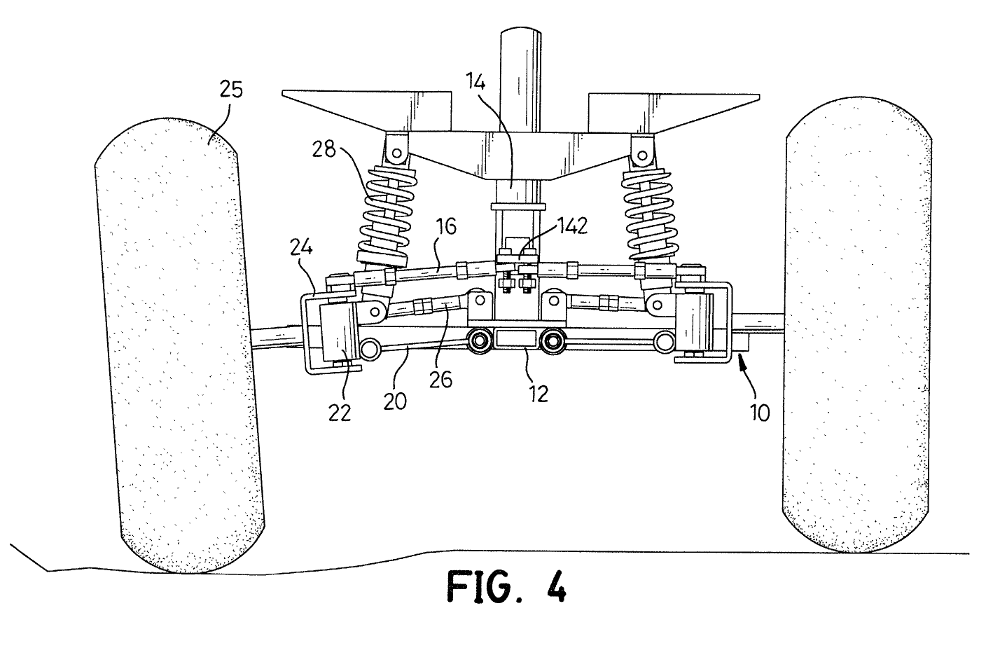

With such an arrangement, the front wheels (25) are respectively connected to the frame (10) of the scooter with the wheel mounts (24), the sleeves (22) and the plates (20). Each front wheel (25) can be independently displaced relative to the frame (10). With reference to FIGS. 3 and 4, when one of the front wheels (25) bumps an object or drops into a pothole in the ground, the wheel mount (24) with the bumped front wheel (25), the attached sleeve (22) and the connected plate (20) will displace relative to the front tube (12) of the frame (10). The shock absorber (28) connected to the bumped front wheel (25) will be pushed or expanded. This can keep the force applied to the front wheel (25) from being transmitted directly to the frame (10) and the steering bar (14). To steer and to drive the scooter is more comfortable.

In addition, because the front wheels (25) are independently suspended, the other wheel front (25) can maintain contact with the ground when one of the front wheels (25) bumps an object or drops into a pothole in the ground. The electric scooter is more stable

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A front wheel suspension assembly for an electric scooter having a frame to which the front wheels are rotatably attached to a front end of the frame, the suspension assembly comprising:
two plates respectively adapted to be pivotally attached to each side of the front end of the frame in a first lateral direction;
a sleeve pivotally attached to each plate in a second lateral direction parallel to the first lateral direction;
a wheel mount pivotally attached to each sleeve in a vertical longitudinal direction perpendicular to the first and second lateral directions and adapted to rotatably mount one of the wheels on each wheel mount; and
a shock absorber with one end pivotally connected to each wheel mount and the other end adapted to be connected to the frame,
thereby the front wheels of the electric scooter can be suspended independently.

2. The suspension assembly as claimed in claim 1 further comprising a connecting bar with one end pivotally connected to each sleeve and the other end adapted to be slidably attached to the frame.
